(19) United States
(12) Patent Application Publication
(10) Pub. No.: US 2026/0261937 A1
(43) Pub. Date: Sep. 3, 2026

(54) DEVICES, METHODS, APPARATUSES, AND COMPUTER READABLE MEDIA FOR NONTERRESTRIAL NETWORK CONNECTION

(71) Applicant: Nokia Technologies Oy, Espoo (FI)

(72) Inventors: Mads LAURIDSEN, Gistrup (DK); Jing Yuan SUN, Beijing (CN); Ping YUAN, Beijing (CN)

(21) Appl. No.: 18/994,654

(22) PCT Filed: Jul. 26, 2022
(86) PCT No.: PCT/CN2022/107843

§ 371 Date: Jan. 15, 2025

(51) Int. Cl. H04W 36/08; G01S 19/38; H04W 24/10; H04W 84/06

(52) U.S. Cl. CPC H04W 36/083; G01S 19/38; H04W 24/10; H04W 84/06

(57) ABSTRACT

Disclosed are devices, methods, apparatuses, and computer readable media for non-terrestrial network connection. An example terminal device may include at least one processor and at least one memory. The at least one memory may store instructions that, when executed by the at least one processor, may cause the terminal device at least to perform: entering into a non-connection mode with respect to a previous serving cell associated with a first network device; determining whether a condition associated with a measurement for at least location information is satisfied; and refraining from reporting a remaining measurement validity duration to a target cell associated with a second network device based on determining that the condition is satisfied.

### TECHNICAL FIELD

Various example embodiments relate to devices, methods, apparatuses, and computer readable media for non-terrestrial network (NTN) connection.

### BACKGROUND

In a NTN, such as narrow band internet of things (NB-IoT) NTN, enhanced machine type communication (eMTC) NTN, etc., for sporadic short connections, a user equipment (UE) in radio resource control (RRC) connected mode should go back to idle mode and re-acquire a global navigation satellite system (GNSS) position fix if GNSS becomes outdated. Moreover, the UE may need to re-acquire the GNSS position fix right before establishing the RRC connection. For the sake of establishing the connection, the UE may autonomously determine its remaining GNSS validity duration and report information associated with this validity duration to network via a RRC signaling. On the other hand, simultaneous GNSS and NTN NB-IoT/eMTC operation is not assumed. So if the UE connects with the network for a long period in general, during which the UE may briefly enter into a non-connection mode, the GNSS position acquisitions may not always be necessary. In this case the GNSS position acquisitions may unnecessarily impact on the NTN NB-IoT/eMTC operation and consume power of the UE, and the remaining GNSS validity duration reporting may unnecessarily cause uplink signaling overhead.

### SUMMARY

A brief summary of exemplary embodiments is provided below to provide basic understanding of some aspects of various embodiments. It should be noted that this summary is not intended to identify key features of essential elements or define scopes of the embodiments, and its sole purpose is to introduce some concepts in a simplified form as a preamble for a more detailed description provided below.

In a first aspect, disclosed is a terminal device. The terminal device may include at least one processor and at least one memory. The at least one memory may store instructions that, when executed by the at least one processor, may cause the terminal device at least to perform: entering into a non-connection mode with respect to a previous serving cell associated with a first network device; determining whether a condition associated with a measurement for at least location information is satisfied; and refraining from reporting a remaining measurement validity duration to a target cell associated with a second network device based on determining that the condition is satisfied.

In some example embodiments, the instructions, when executed by the at least one processor, may cause the terminal device to further perform: refraining from performing a measurement acquisition based on determining that the condition is satisfied.

In some example embodiments, the condition may be satisfied in case of at least one of the following: the target cell is the previous serving cell; the first network device is the second network device; the remaining measurement validity duration exceeds a threshold; or receiving from the second network device an indication indicating that the remaining measurement validity duration is sufficient.

In some example embodiments, the threshold may be predefined, received from the first network device, received from the second network device, or determined by the terminal device.

In some example embodiments, the threshold received from the first network device is a remaining serving time of the previous serving cell.

In some example embodiments, the threshold received from the second network device may be a remaining serving time of the target cell.

In some example embodiments, the threshold determined by the terminal device may be an expected duration of connection with the target cell.

In some example embodiments, the instructions, when executed by the at least one processor, may cause the terminal device to further perform: receiving from the second network device an indication; and reporting the remaining measurement validity duration to the second network device in a case where the indication indicates that the remaining measurement validity duration is absent in the second network device.

In some example embodiments, the instructions, when executed by the at least one processor, may cause the terminal device to further perform: receiving from the second network device an indication; and performing a measurement acquisition in a case where the indication indicates that the remaining measurement validity duration is insufficient.

In some example embodiments, the instructions, when executed by the at least one processor, may cause the terminal device to further perform: receiving from the first network device a remaining serving time of the previous serving cell or from the second network device a remaining serving time of the target cell; and performing a measurement acquisition in a case where the target cell is the previous serving cell, and the remaining measurement validity duration is less than the remaining serving time.

In some example embodiments, the measurement may be based on at least one of the following: a global navigation satellite system, a non-terrestrial network positioning signal, or a terrestrial network positioning signal.

In a second aspect, disclosed is a network device. The network device may include at least one processor and at least one memory. The at least one memory may store instructions that, when executed by the at least one processor, may cause the network device associated with a previous serving cell of a terminal device at least to perform: determining a remaining serving time for the terminal device of the previous serving cell; and transmitting to the terminal device the remaining serving time, wherein the remaining serving time may be used by the terminal device as a threshold to determine whether a condition associated with a measurement for at least location information is satisfied.

In some example embodiments, the measurement may be based on at least one of the following: a global navigation satellite system, a non-terrestrial network positioning signal, or a terrestrial network positioning signal.

In a third aspect, disclosed is a network device. The network device may include at least one processor and at least one memory. The at least one memory may store instructions that, when executed by the at least one processor, may cause the network device associated with a target cell of a terminal device at least to perform: determining whether a remaining measurement validity duration of the terminal device is sufficient for connection with the target cell; and transmitting to the terminal device an indication indicating that the remaining measurement validity duration is sufficient based on determining that the remaining measurement validity duration of the terminal device is sufficient for connection with the target cell, wherein the indication may be used by the terminal device to determine whether a condition associated with a measurement for at least location information is satisfied.

In some example embodiments, the instructions, when executed by the at least one processor, may cause the network device to further perform: transmitting to the terminal device an indication indicating that the remaining measurement validity duration is insufficient based on determining that the remaining measurement validity duration of the terminal device is insufficient for connection with the target cell.

In some example embodiments, the instructions, when executed by the at least one processor, may cause the network device to further perform: transmitting to the terminal device an indication indicating that the remaining measurement validity duration is absent in a case where the remaining measurement validity duration is absent in the network device.

In some example embodiments, the instructions, when executed by the at least one processor, may cause the network device to further perform: determining a remaining serving time for the terminal device of the target cell; and transmitting to the terminal device the remaining serving time.

In some example embodiments, the instructions, when executed by the at least one processor, may cause the network device to further perform: identifying the terminal device as a terminal device of a previous serving cell the remaining measurement validity duration of which the network device keeps.

In some example embodiments, the measurement may be based on at least one of the following: a global navigation satellite system, a non-terrestrial network positioning signal, or a terrestrial network positioning signal.

In a fourth aspect, disclosed is a method performed by a terminal device. The method may comprise: entering into a non-connection mode with respect to a previous serving cell associated with a first network device; determining whether a condition associated with a measurement for at least location information is satisfied; and refraining from reporting a remaining measurement validity duration to a target cell associated with a second network device based on determining that the condition is satisfied.

In some example embodiments, the method may further comprise: refraining from performing a measurement acquisition based on determining that the condition is satisfied.

In some example embodiments, the condition may be satisfied in case of at least one of the following: the target cell is the previous serving cell; the first network device is the second network device; the remaining measurement validity duration exceeds a threshold; or receiving from the second network device an indication indicating that the remaining measurement validity duration is sufficient.

In some example embodiments, the threshold may be predefined, received from the first network device, received from the second network device, or determined by the terminal device.

In some example embodiments, the threshold received from the first network device is a remaining serving time of the previous serving cell.

In some example embodiments, the threshold received from the second network device may be a remaining serving time of the target cell.

In some example embodiments, the threshold determined by the terminal device may be an expected duration of connection with the target cell.

In some example embodiments, the method may further comprise: receiving from the second network device an indication; and reporting the remaining measurement validity duration to the second network device in a case where the indication indicates that the remaining measurement validity duration is absent in the second network device.

In some example embodiments, the method may further comprise: receiving from the second network device an indication; and performing a measurement acquisition in a case where the indication indicates that the remaining measurement validity duration is insufficient.

In some example embodiments, the method may further comprise: receiving from the first network device a remaining serving time of the previous serving cell or from the second network device a remaining serving time of the target cell; and performing a measurement acquisition in a case where the target cell is the previous serving cell, and the remaining measurement validity duration is less than the remaining serving time.

In some example embodiments, the measurement may be based on at least one of the following: a global navigation satellite system, a non-terrestrial network positioning signal, or a terrestrial network positioning signal.

In a fifth aspect, disclosed is a method performed by a network device associated with a previous serving cell of a terminal device. The method may comprise: determining a remaining serving time for the terminal device of the previous serving cell; and transmitting to the terminal device the remaining serving time, wherein the remaining serving time may be used by the terminal device as a threshold to determine whether a condition associated with a measurement for at least location information is satisfied.

In some example embodiments, the measurement may be based on at least one of the following: a global navigation satellite system, a non-terrestrial network positioning signal, or a terrestrial network positioning signal.

In a sixth aspect, disclosed is a method performed by a network device associated with a target cell of a terminal device. The method may comprise: determining whether a remaining measurement validity duration of the terminal device is sufficient for connection with the target cell; and transmitting to the terminal device an indication indicating that the remaining measurement validity duration is sufficient based on determining that the remaining measurement validity duration of the terminal device is sufficient for connection with the target cell, wherein the indication may be used by the terminal device to determine whether a condition associated with a measurement for at least location information is satisfied.

In some example embodiments, the method may further comprise: transmitting to the terminal device an indication indicating that the remaining measurement validity duration is insufficient based on determining that the remaining measurement validity duration of the terminal device is insufficient for connection with the target cell.

In some example embodiments, the method may further comprise: transmitting to the terminal device an indication indicating that the remaining measurement validity duration is absent in a case where the remaining measurement validity duration is absent in the network device.

In some example embodiments, the method may further comprise: determining a remaining serving time for the terminal device of the target cell; and transmitting to the terminal device the remaining serving time.

In some example embodiments, the method may further comprise: identifying the terminal device as a terminal device of a previous serving cell the remaining measurement validity duration of which the network device keeps.

In some example embodiments, the measurement may be based on at least one of the following: a global navigation satellite system, a non-terrestrial network positioning signal, or a terrestrial network positioning signal.

In a seventh aspect, disclosed is an apparatus. The apparatus as a terminal device may comprise: means for entering into a non-connection mode with respect to a previous serving cell associated with a first network device; means for determining whether a condition associated with a measurement for at least location information is satisfied; and means for refraining from reporting a remaining measurement validity duration to a target cell associated with a second network device based on determining that the condition is satisfied.

In some example embodiments, the apparatus may further comprise: means for refraining from performing a measurement acquisition based on determining that the condition is satisfied.

In some example embodiments, the condition may be satisfied in case of at least one of the following: the target cell is the previous serving cell; the first network device is the second network device; the remaining measurement validity duration exceeds a threshold; or receiving from the second network device an indication indicating that the remaining measurement validity duration is sufficient.

In some example embodiments, the threshold may be predefined, received from the first network device, received from the second network device, or determined by the terminal device.

In some example embodiments, the threshold received from the first network device is a remaining serving time of the previous serving cell.

In some example embodiments, the threshold received from the second network device may be a remaining serving time of the target cell.

In some example embodiments, the threshold determined by the terminal device may be an expected duration of connection with the target cell.

In some example embodiments, the apparatus may further comprise: means for receiving from the second network device an indication; and means for reporting the remaining measurement validity duration to the second network device in a case where the indication indicates that the remaining measurement validity duration is absent in the second network device.

In some example embodiments, the apparatus may further comprise: means for receiving from the second network device an indication; and means for performing a measurement acquisition in a case where the indication indicates that the remaining measurement validity duration is insufficient.

In some example embodiments, the apparatus may further comprise: means for receiving from the first network device a remaining serving time of the previous serving cell or from the second network device a remaining serving time of the target cell; and means for performing a measurement acquisition in a case where the target cell is the previous serving cell, and the remaining measurement validity duration is less than the remaining serving time.

In some example embodiments, the measurement may be based on at least one of the following: a global navigation satellite system, a non-terrestrial network positioning signal, or a terrestrial network positioning signal.

In an eighth aspect, disclosed is an apparatus. The apparatus as a network device associated with a previous serving cell of a terminal device may comprise: means for determining a remaining serving time for the terminal device of the previous serving cell; and means for transmitting to the terminal device the remaining serving time, wherein the remaining serving time may be used by the terminal device as a threshold to determine whether a condition associated with a measurement for at least location information is satisfied.

In some example embodiments, the measurement may be based on at least one of the following: a global navigation satellite system, a non-terrestrial network positioning signal, or a terrestrial network positioning signal.

In a ninth aspect, disclosed is an apparatus. The apparatus as a network device associated with a target cell of a terminal device may comprise: means for determining whether a remaining measurement validity duration of the terminal device is sufficient for connection with the target cell; and means for transmitting to the terminal device an indication indicating that the remaining measurement validity duration is sufficient based on determining that the remaining measurement validity duration of the terminal device is sufficient for connection with the target cell, wherein the indication may be used by the terminal device to determine whether a condition associated with a measurement for at least location information is satisfied.

In some example embodiments, the apparatus may further comprise: means for transmitting to the terminal device an indication indicating that the remaining measurement validity duration is insufficient based on determining that the remaining measurement validity duration of the terminal device is insufficient for connection with the target cell.

In some example embodiments, the apparatus may further comprise: means for transmitting to the terminal device an indication indicating that the remaining measurement validity duration is absent in a case where the remaining measurement validity duration is absent in the network device.

In some example embodiments, the apparatus may further comprise: means for determining a remaining serving time for the terminal device of the target cell; and means for transmitting to the terminal device the remaining serving time.

In some example embodiments, the apparatus may further comprise: means for identifying the terminal device as a terminal device of a previous serving cell the remaining measurement validity duration of which the network device keeps.

In some example embodiments, the measurement may be based on at least one of the following: a global navigation satellite system, a non-terrestrial network positioning signal, or a terrestrial network positioning signal.

In a tenth aspect, a computer readable medium is disclosed. The computer readable medium may comprise program instructions that, when executed by a terminal device, may cause the terminal device at least to perform: entering into a non-connection mode with respect to a previous serving cell associated with a first network device; determining whether a condition associated with a measurement for at least location information is satisfied; and refraining from reporting a remaining measurement validity duration to a target cell associated with a second network device based on determining that the condition is satisfied

In some example embodiments, the computer readable medium may further comprise instructions that, when executed by the terminal device, may cause the terminal device to further perform: refraining from performing a measurement acquisition based on determining that the condition is satisfied.

In some example embodiments, the condition may be satisfied in case of at least one of the following: the target cell is the previous serving cell; the first network device is the second network device; the remaining measurement validity duration exceeds a threshold; or receiving from the second network device an indication indicating that the remaining measurement validity duration is sufficient.

In some example embodiments, the threshold may be predefined, received from the first network device, received from the second network device, or determined by the terminal device.

In some example embodiments, the threshold received from the first network device is a remaining serving time of the previous serving cell.

In some example embodiments, the threshold received from the second network device may be a remaining serving time of the target cell.

In some example embodiments, the threshold determined by the terminal device may be an expected duration of connection with the target cell.

In some example embodiments, the computer readable medium may further comprise instructions that, when executed by the terminal device, may cause the terminal device to further perform: receiving from the second network device an indication; and reporting the remaining measurement validity duration to the second network device in a case where the indication indicates that the remaining measurement validity duration is absent in the second network device.

In some example embodiments, the computer readable medium may further comprise instructions that, when executed by the terminal device, may cause the terminal device to further perform: receiving from the second network device an indication; and performing a measurement acquisition in a case where the indication indicates that the remaining measurement validity duration is insufficient.

In some example embodiments, the computer readable medium may further comprise instructions that, when executed by the terminal device, may cause the terminal device to further perform: receiving from the first network device a remaining serving time of the previous serving cell or from the second network device a remaining serving time of the target cell; and performing a measurement acquisition in a case where the target cell is the previous serving cell, and the remaining measurement validity duration is less than the remaining serving time.

In some example embodiments, the measurement may be based on at least one of the following: a global navigation satellite system, a non-terrestrial network positioning signal, or a terrestrial network positioning signal.

In an eleventh aspect, a computer readable medium is disclosed. The computer readable medium may comprise program instructions that, when executed by a network device associated with a previous serving cell of a terminal device, cause the network device at least to perform: determining a remaining serving time for the terminal device of the previous serving cell; and transmitting to the terminal device the remaining serving time, wherein the remaining serving time may be used by the terminal device as a threshold to determine whether a condition associated with a measurement for at least location information is satisfied.

In some example embodiments, the measurement may be based on at least one of the following: a global navigation satellite system, a non-terrestrial network positioning signal, or a terrestrial network positioning signal.

In a twelfth aspect, a computer readable medium is disclosed. The computer readable medium may comprise program instructions that, when executed by a network device associated with a target cell of a terminal device, cause the network device at least to perform: determining whether a remaining measurement validity duration of the terminal device is sufficient for connection with the target cell; and transmitting to the terminal device an indication indicating that the remaining measurement validity duration is sufficient based on determining that the remaining measurement validity duration of the terminal device is sufficient for connection with the target cell, wherein the indication may be used by the terminal device to determine whether a condition associated with a measurement for at least location information is satisfied

In some example embodiments, the computer readable medium may further comprise instructions that, when executed by the network device, may cause the network device to further perform: transmitting to the terminal device an indication indicating that the remaining measurement validity duration is insufficient based on determining that the remaining measurement validity duration of the terminal device is insufficient for connection with the target cell.

In some example embodiments, the computer readable medium may further comprise instructions that, when executed by the network device, may cause the network device to further perform: transmitting to the terminal device an indication indicating that the remaining measurement validity duration is absent in a case where the remaining measurement validity duration is absent in the network device.

In some example embodiments, the computer readable medium may further comprise instructions that, when executed by the network device, may cause the network device to further perform: determining a remaining serving time for the terminal device of the target cell; and transmitting to the terminal device the remaining serving time.

In some example embodiments, the computer readable medium may further comprise instructions that, when executed by the network device, may cause the network device to further perform: identifying the terminal device as a terminal device of a previous serving cell the remaining measurement validity duration of which the network device keeps.

In some example embodiments, the measurement may be based on at least one of the following: a global navigation satellite system, a non-terrestrial network positioning signal, or a terrestrial network positioning signal.

Other features and advantages of the example embodiments of the present disclosure will also be apparent from the following description of specific embodiments when read in conjunction with the accompanying drawings, which illustrate, by way of example, the principles of example embodiments of the present disclosure.

### BRIEF DESCRIPTION OF THE DRAWINGS

Some example embodiments will now be described, by way of non-limiting examples, with reference to the accompanying drawings.

FIG. 1 shows an exemplary sequence diagram for NTN connection according to the example embodiments of the present disclosure.

FIG. 2 shows exemplary scenarios in which a measurement acquisition and the related reporting may be skipped.

FIG. 3 shows an exemplary flow for NTN connection according to the example embodiments of the present disclosure.

FIG. 4 shows a flow chart illustrating an example method 400 for NTN connection according to the example embodiments of the present disclosure.

FIG. 5 shows a flow chart illustrating an example method 500 for NTN connection according to the example embodiments of the present disclosure.

FIG. 6 shows a flow chart illustrating an example method 600 for NTN connection according to the example embodiments of the present disclosure.

FIG. 7 shows a block diagram illustrating an example device 700 for NTN connection according to the example embodiments of the present disclosure.

FIG. 8 shows a block diagram illustrating an example device 800 for NTN connection according to the example embodiments of the present disclosure.

FIG. 9 shows a block diagram illustrating an example device 900 for NTN connection according to the example embodiments of the present disclosure.

FIG. 10 shows a block diagram illustrating an example apparatus 1000 for NTN connection according to the example embodiments of the present disclosure.

FIG. 11 shows a block diagram illustrating an example apparatus 1100 for NTN connection according to the example embodiments of the present disclosure.

FIG. 12 shows a block diagram illustrating an example apparatus 1200 for NTN connection according to the example embodiments of the present disclosure.

Throughout the drawings, same or similar reference numbers indicate same or similar elements. A repetitive description on the same elements would be omitted.

### DETAILED DESCRIPTION

Herein below, some example embodiments are described in detail with reference to the accompanying drawings. The following description includes specific details for the purpose of providing a thorough understanding of various concepts. However, it will be apparent to those skilled in the art that these concepts may be practiced without these specific details. In some instances, well known circuits, techniques and components are shown in block diagram form to avoid obscuring the described concepts and features.

Example embodiments of the present disclosure provide a solution for NTN connection. According to the example embodiments of the present disclosure, a UE may not be forced to perform a measurement for at least location information based on such as a GNSS, a NTN positioning signal, a terrestrial network (TN) positioning signal, etc., if the UE briefly enters into the non-connection mode during a general long connection, and thus UE energy saving can be achieved. Further, the UE may not be forced to report the remaining validity duration of the measurement result, and thus unnecessary uplink signaling overhead may be reduced, moreover, the network can avoid updating the remaining validity duration variable of the measurement result and thus save some processing power.

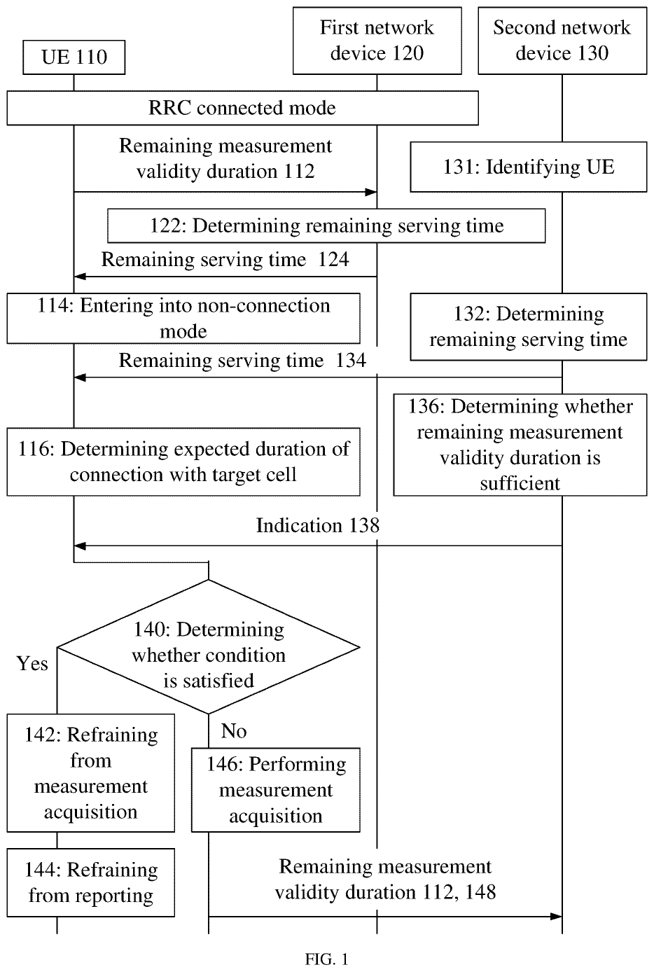

FIG. 1 shows an exemplary sequence diagram for NTN connection according to the example embodiments of the present disclosure. Referring to the FIG. 1, a UE 110 may represent any terminal device in a NTN. A first network device 120 may function as a base station (BS) in the NTN and be associated with a cell previously serving the UE 110. A second network device 130 may function as a BS in the NTN and be associated with a target cell the UE 110 will connect with after a briefly entering into a non-connection mode with respect to the previous serving cell. In the NTN, the BS may be located for example at a satellite.

Initially, the UE 110 is in a RRC connected mode with the serving cell associated with first network device 120. In the RRC connected mode, the UE 110 has performed a measurement for at least location information and reported the measurement result and a remaining measurement validity duration 112 to the first network device 120.

In the example embodiments, the measurement for at least the location information may be based on at least one of the following: a GNSS, a NTN positioning signal, or a TN positioning signal. In an embodiment, the measurement may be based on the GNSS, such as global positioning system (GPS), Galileo satellite navigation system, Beidou navigation satellite system, etc. In this case, the measurement based on the GNSS may provide both UE location information and accurate time. Alternatively or additionally, the measurement for the location information may be based on the NTN positioning signal, or the TN positioning signal.

In the example embodiments, the remaining measurement validity duration may refer to a remaining duration during which a preceding measurement result obtained from a preceding measurement acquisition may be valid. For example, the remaining GNSS validity duration may be the remaining duration during which the preceding GNSS measurement result may be valid. Assuming that the measurement validity duration obtained from the preceding measurement acquisition is d1, and from the preceding measurement acquisition a time duration d2 has passed, then the remaining measurement validity duration obtained from the preceding measurement acquisition is a value of (d1−d2).

It may be appreciated that in the present disclosure the terms “acquisition” and “reacquisition” with respect to the measurement for at least the location information refer to the same or substantially identical meaning and would not result in substantially different outcomes, and in the present disclosure the term “acquisition” is used and may also refer to the situation of term “reacquisition.”

In an operation 114, the UE 110 may enter into a non-connection mode with respect to a previous serving cell associated with the first network device 120. The non-connection mode may be for example a RRC idle mode, a RRC inactive mode, a RRC suspend mode, etc. In a case where the UE 110 is briefly in the non-connection mode, when the UE 110 is to establish connection with a target cell, for example, in the cases such as attempting a random access (RA), reestablishing the RRC connection, resuming the RRC connection, handover, etc., in an operation 140, the UE 110 may determine whether a condition associated with the measurement for at least the location information is satisfied and decide whether to perform a measurement acquisition and/or report the remaining measurement validity duration based on the determination.

In an embodiment, before the operation 114, when the UE 110 is RRC connected with the serving cell associated with the first network device 120, which becomes the previous serving cell when the UE 110 may enter into a non-connection mode in the operation 114, in an operation 122, the first network device 120 may determine a remaining serving time 124 for the UE 110 of the serving cell. For example, when the UE 110 is to enter into the non-connection mode with respect to the serving cell, in the operation 122, the first network device 120 may estimate the remaining serving time 124 of the serving cell. The remaining serving time 124 may be the remaining serving duration for the previously reported location of the UE 110. For example, the remaining serving time 124 may be the remaining duration the serving cell may serve the UE 110 at the previously reported location. Then, the first network device 120 may transmit the remaining serving time 124 to the UE 110, for example as a part of the RRC connection release message.

In this embodiment, the remaining serving time 124 may be used by the UE 110 as a threshold to determine whether the condition is satisfied in the operation 140. For example, in the operation 140, if the remaining measurement validity duration 112 exceeds the remaining serving time 124, the UE 110 may determine the condition is satisfied. In this case, before the connection is established, in an operation 142, the UE 110 may refrain from performing the measurement acquisition based on determining that the condition is satisfied. After the connection is established, in an operation 144, the UE 110 may refrain from reporting the remaining measurement validity duration to the target cell associated with the second network device 130 based on determining that the condition is satisfied.

Alternatively or additionally, in an embodiment, the threshold may be predefined in a specification or standard. In the operation 140, if the remaining measurement validity duration 112 exceeds the threshold, the UE 110 may determine the condition is satisfied. In this case, in the operation 142 the UE 110 may refrain from performing the measurement acquisition, and in the operation 144 the UE 110 may refrain from reporting the remaining measurement validity duration.

Alternatively or additionally, in an embodiment, the threshold may be determined by the UE 110. For example, in an operation 116, the UE 110 may determine an expected duration of connection with the target cell. The UE 110 may estimate a duration of connection with the target cell as the threshold. In this case, the threshold may be specific to the UE 110. Then, the UE 110 may determine the condition is satisfied in the operation 140 if the remaining measurement validity duration 112 exceeds the expected duration of connection with the target cell.

Alternatively or additionally, in an embodiment, the threshold may be received from the second network device 130. For example, in an operation 132, the second network device 130 may determine a remaining serving time 134 for the UE 110 of the target cell when finding the UE 110 is to establish connection with the target cell. Similar to the remaining serving time 124, the remaining serving time 134 may be the remaining duration the target cell may serve the UE 110 at the previously reported location. If the second network device 130 is not the first network device 120, the second network device 130 may get the previously reported location of the UE 110 from the first network device 120. Then, the second network device 130 may transmit the remaining serving time 134 to the UE 110, for example as a part of the message 2 (Msg2) which may be a random access response (RAR), the message 4 (Msg4), or the message B (MsgB) of the RA procedure.

In a case where there are more than one thresholds at the UE 110, the UE 110 may apply the maximum, the minimum, or an average of the thresholds as the threshold for determining whether the condition is satisfied. It may be appreciated that the remaining measurement validity duration, the remaining serving time 124 as well as the remaining serving time 134 vary with the time lapses.

Before the operation 132, in an operation 131 the second network device 130 may identify the UE 110 as a UE of the previous serving cell, such that the second network device 130 may link the UE 110 to the measurement result for at least the location information and the remaining measurement validity duration 112 previously reported to the first network device 120. If the second network device 130 is not the first network device 120, the second network device 130 may get from the first network device 120 and keep the measurement results including at least the location information and the remaining measurement validity durations of the UEs of the previous serving cell associated with the first network device 120.

For example, a preamble identifier (ID) allocated by the network in a contention-free random access (CFRA) may be used to identify the UE 110 as the UE of the previous serving cell e.g. during handover. Alternatively, if the UE 110 is to reestablish the RRC connection, the UE 110 may provide former cell radio network temporary identifier (C-RNTI) in the message 3 (Msg3) as a part of RRC reestablishment message. Alternatively, if the UE 110 is to resume the RRC connection, the UE 110 may provide former C-RNTI in a resume identity as a part of RRC resume message. The former C-RNTI may be used to identify the UE 110 as the UE of the previous serving cell.

Alternatively or additionally, in an embodiment, in an operation 136, the second network device 130 may determine whether the remaining measurement validity duration 112 of the UE 110 is sufficient for connection with the target cell. For example, the second network device 130 may find that it keeps the remaining measurement validity duration 112 of the UE 110 by identifying that the UE 110 is a UE of the previous serving cell. Then, the second network device 130 may transmit to the UE 110 an indication 138 indicating that the remaining measurement validity duration 112 is sufficient based on determining that the remaining measurement validity duration 112 of the UE 110 is sufficient for connection with the target cell. The indication 138 may be transmitted for example as a part of the Msg2 which may be the RAR, the Msg4, or the MsgB of the RA procedure.

In this case, on the UE side, if the UE 110 receives from the second network device an indication indicating that the remaining measurement validity duration is sufficient, in the operation 140, the UE 110 may determine that the condition is satisfied.

Alternatively or additionally, in an embodiment, if the target cell is the previous serving cell, in which case the UE 110 is to establish connection with the previous serving cell, in the operation 140, the UE 110 may determine that the condition is satisfied because the UE 110 has already reported to the first network device 120, the measurement result for at least the location information and the remaining measurement validity duration 112.

Alternatively or additionally, in an embodiment, if the first network device 120 is the second network device 130, in which case the target cell and the previous serving cell are associated with the same BS, the UE 110 may determine that the condition is satisfied because the BS may share the measurement result for at least the location information and the remaining measurement validity duration 112 among the cells of the BS.

In some example embodiments, the condition may be satisfied in case of at least one of the following: the target cell is the previous serving cell; the first network device 120 is the second network device 130; the remaining measurement validity duration 112 exceeds the threshold; or receiving from the second network device 130 an indication 138 indicating that the remaining measurement validity duration 112 is sufficient. If the condition is satisfied (“Yes” prong of the operation 140), in the operation 142 the UE 110 may refrain from performing the measurement acquisition and in the operation 144 the UE 110 may refrain from reporting the remaining measurement validity duration 112 to the target cell. In this case, in an embodiment, as a part of the RA procedure, the UE 110 may indicate that the target cell cab reuse the previously reported remaining measurement validity duration 112.

In an embodiment, in a case where the indication 138 indicates that the remaining measurement validity duration 112 is absent in the second network device 130, in the operation 140, the UE 110 may determine that the condition is unsatisfied. For example, the second network device 130 may transmit to the UE 110 the indication 138 indicating that the remaining measurement validity duration 112 is absent in a case where the remaining measurement validity duration 112 is absent in the second network device 130. In this case (“No” prong of the operation 140), the UE 110 may report the remaining measurement validity duration 112 to the second network device 130 after the establishment of the connection.

In an embodiment, in a case where the indication 138 indicates that the remaining measurement validity duration 112 is insufficient, in the operation 140, the UE 110 may determine that the condition is unsatisfied. For example, the second network device 130 may transmit to the UE 110 the indication 138 indicating that the remaining measurement validity duration 112 is insufficient based on in the operation 136 determining that the remaining measurement validity duration 112 of the UE 110 is insufficient for connection with the target cell. In this case (“No” prong of the operation 140), the UE 110 may abort the connection setup and in an operation 146 perform a measurement acquisition to acquire the measurement result for at least the location information, and then report the newly acquired measurement result and the corresponding remaining measurement validity duration 148 to the second network device 130 after the establishment of the connection.

In an embodiment, the UE 110 may receive from the first network device 120 the remaining serving time 124 of the previous serving cell or from the second network device 130 the remaining serving time 134 of the target cell. In a case where the target cell is the previous serving cell, in which case the remaining serving time 124 is the remaining serving time 134, and the remaining measurement validity duration 112 is less than the remaining serving time 124 or 134, in the operation 140, the UE 110 may determine that the condition is unsatisfied. In this case (“No” prong of the operation 140), the UE 110 may in the operation 146 perform the measurement acquisition to acquire the measurement result for at least the location information, and then report the newly acquired measurement result and the corresponding remaining measurement validity duration 148 to the second network device 130 after the establishment of the connection.

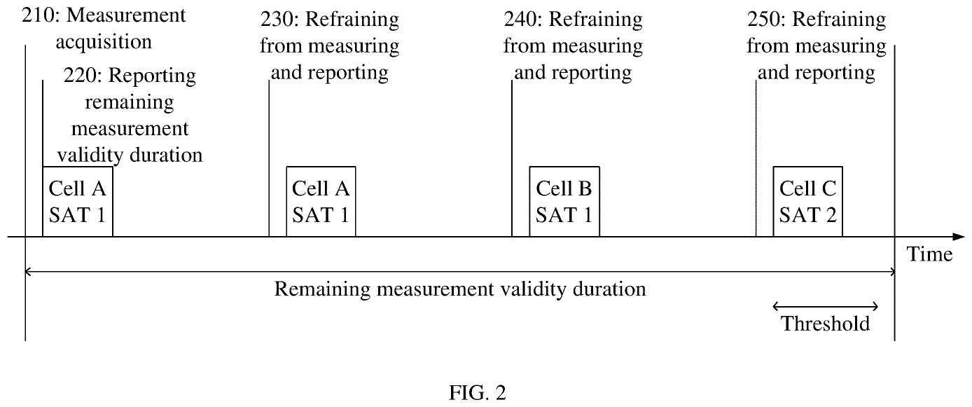

FIG. 2 shows exemplary scenarios in which a measurement acquisition and the related reporting may be skipped. It is assumed that the UE 110, the first network device 120, and the second network device 130 operate in the exemplary scenarios. Details which have been described with respect to the FIG. 1 are simply described or omitted.

Referring to the FIG. 2, initially the UE 110 is in RRC connected mode with a serving cell denoted as Cell A associated with the first network device 120 on a satellite (SAT) 1, and in an operation 210, the UE 110 performs a measurement acquisition. The measurement may be based on at least one of the following: the GNSS, the NTN positioning signal, or the TN positioning signal, and the measurement result may include at least location information. In the operation 210, the UE 110 may also determine the remaining measurement validity duration and in an operation 220, the UE 110 reports the remaining measurement validity duration to the first network device 120. Then, the UE 110 briefly enters into a non-connection mode with respect to the Cell A, and the Cell A becomes the previous serving cell of the UE 110. When the UE 110 is to establish connection with a target cell, in some exemplary scenarios, the UE 110 may skip the measurement acquisition and skip reporting the remaining measurement validity duration.

For example, if the target cell is the Cell A which is previous serving cell of the UE 110, in an operation 230, the UE 110 may refrain from performing the measurement acquisition and may refrain from reporting the remaining measurement validity duration to the target cell.

Alternatively or additionally, for example, in a case where the target cell is a Cell B different from the Cell A, if the Cell B is also associated with the first network device 120 on the SAT 1, in an operation 240, the UE 110 may refrain from performing the measurement acquisition and may refrain from reporting the remaining measurement validity duration to the target cell.

Alternatively or additionally, for example, in a case where the target cell is a Cell C associated with the second network device 130 on a SAT 2 different from the SAT 1, if the remaining measurement validity duration exceeds the threshold e.g. as is described with respect to the FIG. 1 when the UE 110 is to establish connection with the Cell C, in an operation 250, the UE 110 may refrain from performing the measurement acquisition and may refrain from reporting the remaining measurement validity duration to the target cell.

It may be appreciated that the order for determining whether the condition e.g. as is described with respect to the operation 140 is satisfied is not limited to the examples shown in the FIG. 2. For example, the determination with respect to the threshold may be performed before the determination with respect to the same cell or the same satellite.

FIG. 3 shows an exemplary flow for NTN connection according to the example embodiments of the present disclosure. It is assumed that the UE 110, the first network device 120, and the second network device 130 operate according to the exemplary flow. Details which have been described with respect to the FIG. 1 or the FIG. 2 are simply described or omitted.

Referring to the FIG. 3, in an operation 310, the UE 110 is in RRC connected mode with a serving cell associated with the first network device 120, performs a measurement acquisition, and reports the measurement result and the remaining measurement validity duration to the first network device 120. Then, in an operation 312, the UE 110 briefly enters into a non-connection mode with respect to the previous serving cell associated with the first network device 120. When the UE 110 is to establish connection with a target cell, the UE 110 may determine whether a condition associated with the measurement for at least the location information, e.g. as is described with respect to the operation 140, is satisfied and decide whether to perform a measurement acquisition and/or report the remaining measurement validity duration based on the determination.

In an operation 314, the UE 110 may determine whether the target cell is the same as the previous serving cell. If the target cell is the same as the previous serving cell (“Yes” prong of the operation 314), in an embodiment, the UE 110 may determine the condition is satisfied. In this case, the UE 110 may refrain from performing the measurement acquisition in an operation 322 and may refrain from reporting the remaining measurement validity duration to the target cell in an operation 324.

Alternatively, as an option, if the target cell is the same as the previous serving cell (“Yes” prong of the operation 314), in an embodiment, in an operation 330, the UE 110 may determine whether the remaining measurement validity duration exceeds the remaining serving duration of the target cell which is also the previous serving cell. If the remaining measurement validity duration exceeds the remaining serving duration of the target cell (“Yes” prong of the operation 330), the UE 110 may refrain from performing the measurement acquisition in the operation 322 and may refrain from reporting the remaining measurement validity duration to the target cell in the operation 324. If the remaining measurement validity duration is less than the remaining serving duration of the target cell (“No” prong of the operation 330), the UE 110 may perform a measurement acquisition in an operation 326 and may report the new remaining measurement validity duration to the target cell in an operation 328.

If the target cell is different from the previous serving cell (“No” prong of the operation 314), in an operation 316, the UE 110 may determine whether the target cell is associated with the same BS as the previous serving cell. If the target cell and the previous serving cell are associated with the same BS, e.g. the same satellite, in which case the first network device 120 is the second network device 130 (“Yes” prong of the operation 316), the UE 110 may determine the condition is satisfied. In this case, the UE 110 may refrain from performing the measurement acquisition in an operation 322 and may refrain from reporting the remaining measurement validity duration to the target cell in an operation 324.

If the target cell and the previous serving cell are associated with different BSs, e.g. the first network device 120 is not the second network device 130 (“No” prong of the operation 316), in an operation 318 the UE 110 may determine whether the remaining measurement validity duration exceeds the threshold. The threshold may be e.g. the threshold described with respect to the FIG. 1. If the remaining measurement validity duration exceeds the threshold (“Yes” prong of the operation 318), the UE 110 may determine the condition is satisfied. In this case, the UE 110 may refrain from performing the measurement acquisition in the operation 322 and may refrain from reporting the remaining measurement validity duration to the target cell in the operation 324.

If the remaining measurement validity duration does is less than the threshold (“No” prong of the operation 318), in an operation 320 the UE 110 may determine whether the indication from the second network device 130 is received and whether the indication indicates that the remaining measurement validity duration is sufficient for connection with the target cell. The indication may be e.g. the indication 138 described with respect to the FIG. 1.

If the UE 110 has received the indication 138 indicating that the remaining measurement validity duration is sufficient (“Yes” prong of the operation 320), the UE 110 may determine the condition is satisfied. In this case, the UE 110 may refrain from performing the measurement acquisition in the operation 322 and may refrain from reporting the remaining measurement validity duration to the target cell in the operation 324.

If the UE 110 has not received the indication 138 indicating that the remaining measurement validity duration is sufficient, or the UE 110 has received the indication 138 indicating that the remaining measurement validity duration is insufficient for connection with the target cell (“No” prong of the operation 320), the UE 110 may perform the measurement acquisition in the operation 326 and may report the new remaining measurement validity duration to the target cell in the operation 328.

Alternatively, if the UE 110 has received the indication 138 indicating that the remaining measurement validity duration is absent in the second network device 130 (“No” prong of the operation 320), the UE 110 may report the remaining measurement validity duration to the target cell in the operation 328.

It may be appreciated that the order for determining whether the condition is satisfied is not limited to the flow shown in the FIG. 3 and not all the operations 314, 316, 318, 320, 330, etc. need to be performed. For example, the operation 320 and/or the operation 318 may be performed before the operation 314.

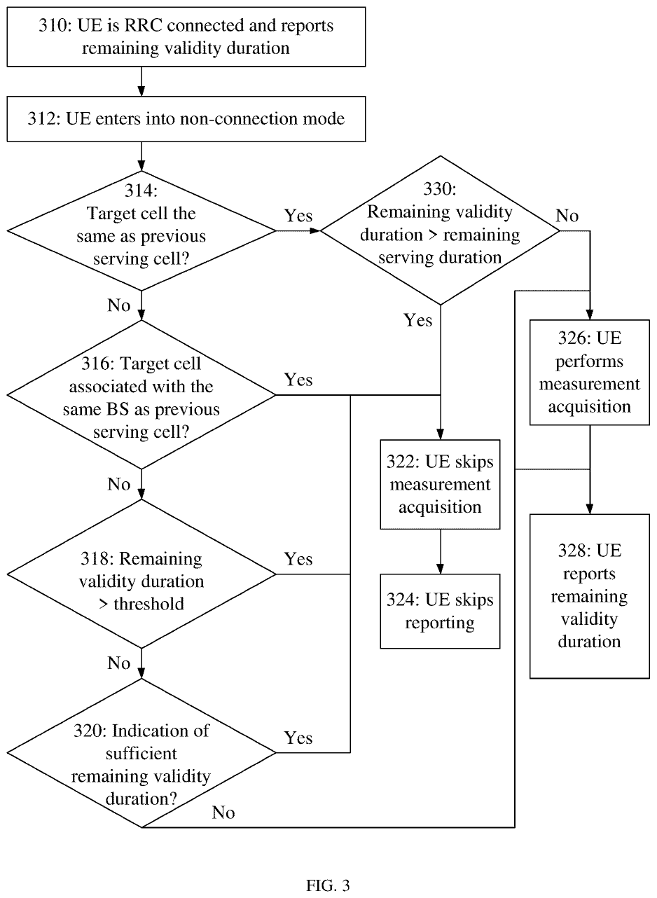

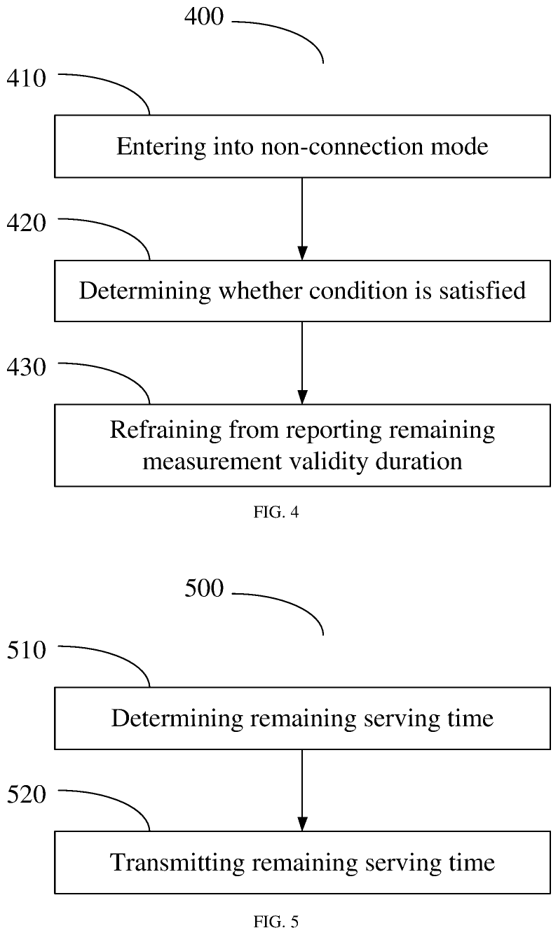

FIG. 4 shows a flow chart illustrating an example method 400 for NTN connection according to the example embodiments of the present disclosure. The example method 400 may be performed for example by a terminal device such as the UE 110.

Referring to the FIG. 4, the example method 400 may include an operation 410 of entering into a non-connection mode with respect to a previous serving cell associated with a first network device; an operation 420 of determining whether a condition associated with a measurement for at least location information is satisfied; and an operation 430 of refraining from reporting a remaining measurement validity duration to a target cell associated with a second network device based on determining that the condition is satisfied.

Details of the operation 410 have been described in the above descriptions with respect to at least the operation 114 and the operation 312, and repetitive descriptions thereof are omitted here.

Details of the operation 420 have been described in the above descriptions with respect to at least the operation 140, the FIG. 2 and the operations 314, 316, 318, 320, and 330, and repetitive descriptions thereof are omitted here.

Details of the operation 430 have been described in the above descriptions with respect to at least the operation 324, the operations 230, 240 and 250, and the operation 324, and repetitive descriptions thereof are omitted here.

In an embodiment, the example method 400 may further include an operation of refraining from performing a measurement acquisition based on determining that the condition is satisfied. The more details have been described in the above descriptions with respect to at least the operation 142, the operations 230, 240 and 250, and the operation 322, and repetitive descriptions thereof are omitted here.

In an embodiment, the condition may be satisfied in case of at least one of the following: the target cell is the previous serving cell; the first network device is the second network device; the remaining measurement validity duration exceeds a threshold; or receiving from the second network device an indication indicating that the remaining measurement validity duration is sufficient. The more details have been described in the above descriptions with respect to at least the operation 140, the FIG. 2 and the operations 314, 316, 318, and 320, and repetitive descriptions thereof are omitted here.

In an embodiment, the threshold may be predefined, received from the first network device, received from the second network device, or determined by the terminal device. The more details have been described in the above descriptions with respect to at least the threshold, the remaining serving time 124, the operation 116, and the remaining serving time 134, and repetitive descriptions thereof are omitted here.

In an embodiment, the threshold received from the first network device may be a remaining serving time of the previous serving cell. The more details have been described in the above descriptions with respect to at least the remaining serving time 124, and repetitive descriptions thereof are omitted here.

In an embodiment, the threshold received from the second network device may be a remaining serving time of the target cell. The more details have been described in the above descriptions with respect to at least the remaining serving time 134, and repetitive descriptions thereof are omitted here.

In an embodiment, the threshold determined by the terminal device may be an expected duration of connection with the target cell. The more details have been described in the above descriptions with respect to at least the operation 116, and repetitive descriptions thereof are omitted here.

In an embodiment, the example method 400 may further include an operation of receiving from the second network device an indication; and an operation of reporting the remaining measurement validity duration to the second network device in a case where the indication indicates that the remaining measurement validity duration is absent in the second network device. The more details have been described in the above descriptions with respect to at least the indication 138, the remaining measurement validity duration 112, the operation 320, and the operation 328, and repetitive descriptions thereof are omitted here.

In an embodiment, the example method 400 may further include an operation of receiving from the second network device an indication; and an operation of performing a measurement acquisition in a case where the indication indicates that the remaining measurement validity duration is insufficient. The more details have been described in the above descriptions with respect to at least the indication 138, the operation 146, the operation 320, and the operation 326, and repetitive descriptions thereof are omitted here.

In an embodiment, the example method 400 may further include an operation of receiving from the first network device a remaining serving time of the previous serving cell or from the second network device a remaining serving time of the target cell; and an operation of performing a measurement acquisition in a case where the target cell is the previous serving cell, and the remaining measurement validity duration is less than the remaining serving time. The more details have been described in the above descriptions with respect to at least the operation 140, the operation 146, the operation 314, the operation 330, and the operation 326, and repetitive descriptions thereof are omitted here.

In an embodiment, the measurement may be based on at least one of the following: a GNSS, a NTN positioning signal, or a TN positioning signal.

FIG. 5 shows a flow chart illustrating an example method 500 for NTN connection according to the example embodiments of the present disclosure. The example method 500 may be performed for example by a network device such as the first network device 120 associated with a previous serving cell of a terminal device such as the UE 110.

Referring to the FIG. 5, the example method 500 may include an operation 510 of determining a remaining serving time for the terminal device of the previous serving cell; and an operation 320 of transmitting to the terminal device the remaining serving time, wherein the remaining serving time may be used by the terminal device as a threshold to determine whether a condition associated with a measurement for at least location information is satisfied.

Details of the operation 310 have been described in the above descriptions with respect to at least the operation 122 and the remaining serving time 124, and repetitive descriptions thereof are omitted here.

Details of the operation 320 have been described in the above descriptions with respect to at least the remaining serving time 124 and the operation 140, and repetitive descriptions thereof are omitted here.

In an embodiment, the measurement may be based on at least one of the following: a GNSS, a NTN positioning signal, or a TN positioning signal.

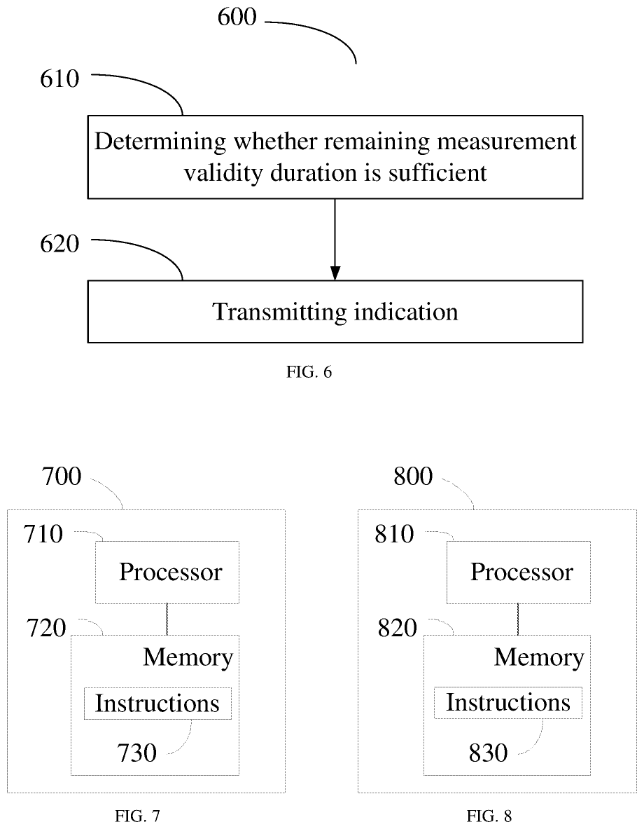

FIG. 6 shows a flow chart illustrating an example method 600 for NTN connection according to the example embodiments of the present disclosure. The example method 600 may be performed for example by a network device such as the second network device 130 associated with a target cell of a terminal device such as the UE 110.

Referring to the FIG. 6, the example method 600 may include an operation 610 of determining whether a remaining measurement validity duration of the terminal device is sufficient for connection with the target cell; and an operation 420 of transmitting to the terminal device an indication indicating that the remaining measurement validity duration is sufficient based on determining that the remaining measurement validity duration of the terminal device is sufficient for connection with the target cell, wherein the indication may be used by the terminal device to determine whether a condition associated with a measurement for at least location information is satisfied.

Details of the operation 610 have been described in the above descriptions with respect to at least the operation 136, and repetitive descriptions thereof are omitted here.

Details of the operation 620 have been described in the above descriptions with respect to at least the indication 138, the operation 140, and the operation 320, and repetitive descriptions thereof are omitted here.

In an embodiment, the example method 600 may further include an operation of transmitting to the terminal device an indication indicating that the remaining measurement validity duration is insufficient based on determining that the remaining measurement validity duration of the terminal device is insufficient for connection with the target cell. The more details have been described in the above descriptions with respect to at least the indication 138, the operation 140, and the operation 320, and repetitive descriptions thereof are omitted here.

In an embodiment, the example method 600 may further include an operation of transmitting to the terminal device an indication indicating that the remaining measurement validity duration is absent in a case where the remaining measurement validity duration is absent in the network device. The more details have been described in the above descriptions with respect to at least the indication 138, the operation 140, and the operation 320, and repetitive descriptions thereof are omitted here.

In an embodiment, the example method 600 may further include an operation of determining a remaining serving time for the terminal device of the target cell; and an operation of transmitting to the terminal device the remaining serving time. The more details have been described in the above descriptions with respect to at least the operation 132 and the remaining serving time 134, and repetitive descriptions thereof are omitted here.

In an embodiment, the example method 600 may further include an operation of identifying the terminal device as a terminal device of a previous serving cell the remaining measurement validity duration of which the network device keeps. The more details have been described in the above descriptions with respect to at least the operation 131, and repetitive descriptions thereof are omitted here.

In an embodiment, the measurement may be based on at least one of the following: a GNSS, a NTN positioning signal, or a TN positioning signal.

FIG. 7 shows a block diagram illustrating an example device 700 for NTN connection according to the example embodiments of the present disclosure. The device, for example, may be at least part of a terminal device such as the UE 110 in the above examples.

As shown in the FIG. 7, the example device 700 may include at least one processor 710 and at least one memory 720 that may store instructions 730. The instructions 730, when executed by the at least one processor 710, may cause the device 700 at least to perform the example method 400 described above.

In various example embodiments, the at least one processor 710 in the example device 700 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 710 may also include at least one other circuitry or element not shown in the FIG. 7.

In various example embodiments, the at least one memory 720 in the example device 700 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 720 may include, but are not limited to, an electric, a magnetic, an optical, an electromagnetic, an infrared, or a semiconductor system, apparatus, or device or any combination of the above.

Further, in various example embodiments, the example device 700 may also include at least one other circuitry, element, and interface, for example at least one I/O interface, at least one antenna element, and the like.

In various example embodiments, the circuitries, parts, elements, and interfaces in the example device 700, including the at least one processor 710 and the at least one memory 720, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the UE 110 is not limited to the above example device 700.

FIG. 8 shows a block diagram illustrating an example device 800 for NTN connection according to the example embodiments of the present disclosure. The device, for example, may be at least part of a network device such as the first network device 120 associated with a previous serving cell of a terminal device such as the UE 110 in the above examples.

As shown in the FIG. 8, the example device 800 may include at least one processor 810 and at least one memory 820 that may store instructions 830. The instructions 830, when executed by the at least one processor 810, may cause the device 800 at least to perform the example method 500 described above.

In various example embodiments, the at least one processor 810 in the example device 800 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 810 may also include at least one other circuitry or element not shown in the FIG. 8.

In various example embodiments, the at least one memory 820 in the example device 800 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 820 may include, but are not limited to, an electric, a magnetic, an optical, an electromagnetic, an infrared, or a semiconductor system, apparatus, or device or any combination of the above.

Further, in various example embodiments, the example device 800 may also include at least one other circuitry, element, and interface, for example at least one I/O interface, at least one antenna element, and the like.

In various example embodiments, the circuitries, parts, elements, and interfaces in the example device 800, including the at least one processor 810 and the at least one memory 820, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the first network device 120 is not limited to the above example device 800.

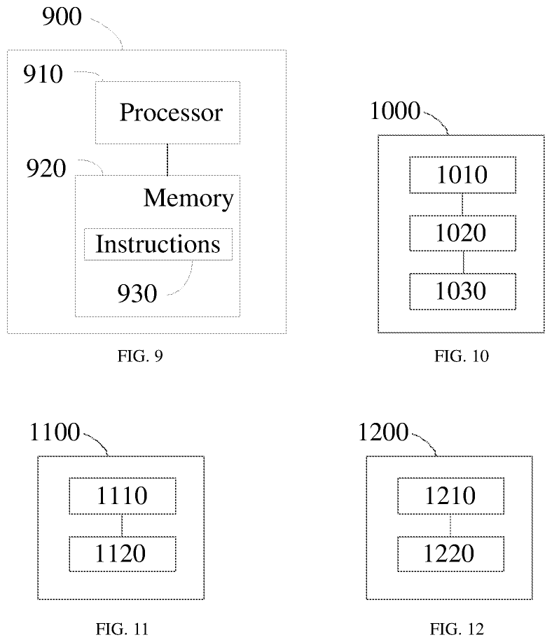

FIG. 9 shows a block diagram illustrating an example device 900 for NTN connection according to the example embodiments of the present disclosure. The device, for example, may be at least part of a network device such as the second network device 130 associated with a target cell of a terminal device such as the UE 110 in the above examples.

As shown in the FIG. 9, the example device 900 may include at least one processor 910 and at least one memory 920 that may store instructions 930. The instructions 930, when executed by the at least one processor 910, may cause the device 900 at least to perform the example method 600 described above.

In various example embodiments, the at least one processor 910 in the example device 900 may include, but not limited to, at least one hardware processor, including at least one microprocessor such as a central processing unit (CPU), a portion of at least one hardware processor, and any other suitable dedicated processor such as those developed based on for example Field Programmable Gate Array (FPGA) and Application Specific Integrated Circuit (ASIC). Further, the at least one processor 910 may also include at least one other circuitry or element not shown in the FIG. 9.

In various example embodiments, the at least one memory 920 in the example device 900 may include at least one storage medium in various forms, such as a transitory memory and/or a non-transitory memory. The transitory memory may include, but not limited to, for example, a random-access memory (RAM), a cache, and so on. The non-transitory memory may include, but not limited to, for example, a read only memory (ROM), a hard disk, a flash memory, and so on. The term “non-transitory,” as used herein, is a limitation of the medium itself (i.e., tangible, not a signal) as opposed to a limitation on data storage persistency (e.g., RAM vs. ROM). Further, the at least memory 920 may include, but are not limited to, an electric, a magnetic, an optical, an electromagnetic, an infrared, or a semiconductor system, apparatus, or device or any combination of the above.

Further, in various example embodiments, the example device 900 may also include at least one other circuitry, element, and interface, for example at least one I/O interface, at least one antenna element, and the like.

In various example embodiments, the circuitries, parts, elements, and interfaces in the example device 900, including the at least one processor 910 and the at least one memory 920, may be coupled together via any suitable connections including, but not limited to, buses, crossbars, wiring and/or wireless lines, in any suitable ways, for example electrically, magnetically, optically, electromagnetically, and the like.

It is appreciated that the structure of the device on the side of the second network device 130 is not limited to the above example device 900.

FIG. 10 shows a block diagram illustrating an example apparatus 1000 for NTN connection according to the example embodiments of the present disclosure. The apparatus, for example, may be at least part of a terminal device such as the UE 110 in the above examples.

As shown in FIG. 10, the example apparatus 1000 may include means 1010 for performing the operation 410 of the example method 400, means 1020 for performing the operation 420 of the example method 400, and means 1030 for performing the operation 430 of the example method 400. In one or more another example embodiments, at least one I/O interface, at least one antenna element, and the like may also be included in the example apparatus 1000.

In an embodiment, the example apparatus 1000 may further include means for refraining from performing a measurement acquisition based on determining that the condition is satisfied.

In an embodiment, the condition may be satisfied in case of at least one of the following: the target cell is the previous serving cell; the first network device is the second network device; the remaining measurement validity duration exceeds a threshold; or receiving from the second network device an indication indicating that the remaining measurement validity duration is sufficient.

In an embodiment, the threshold may be predefined, received from the first network device, received from the second network device, or determined by the terminal device.

In an embodiment, the threshold received from the first network device may be a remaining serving time of the previous serving cell.

In an embodiment, the threshold received from the second network device may be a remaining serving time of the target cell.

In an embodiment, the threshold determined by the terminal device may be an expected duration of connection with the target cell.

In an embodiment, the example apparatus 1000 may further include means for receiving from the second network device an indication; and means for reporting the remaining measurement validity duration to the second network device in a case where the indication indicates that the remaining measurement validity duration is absent in the second network device.

In an embodiment, the example apparatus 1000 may further include means for receiving from the second network device an indication; and means for performing a measurement acquisition in a case where the indication indicates that the remaining measurement validity duration is insufficient.

In an embodiment, the example apparatus 1000 may further include means for receiving from the first network device a remaining serving time of the previous serving cell or from the second network device a remaining serving time of the target cell; and means for performing a measurement acquisition in a case where the target cell is the previous serving cell, and the remaining measurement validity duration is less than the remaining serving time.

In an embodiment, the measurement may be based on at least one of the following: a GNSS, a NTN positioning signal, or a TN positioning signal.

In some example embodiments, examples of means in the example apparatus 1000 may include circuitries. For example, an example of means 1010 may include a circuitry configured to perform the operation 410 of the example method 400, an example of means 1020 may include a circuitry configured to perform the operation 420 of the example method 400, and an example of means 1030 may include a circuitry configured to perform the operation 430 of the example method 400.

The example apparatus 1000 may further include means comprising circuitry configured to perform the example method 400. In some example embodiments, examples of means may also include software modules and any other suitable function entities.

FIG. 11 shows a block diagram illustrating an example apparatus 1100 for NTN connection according to the example embodiments of the present disclosure. The apparatus, for example, may be at least part of a network device such as the first network device 120 associated with a previous serving cell of a terminal device such as the UE 110 in the above examples.

As shown in FIG. 11, the example apparatus 1100 may include means 1110 for performing the operation 510 of the example method 500, and means 1120 for performing the operation 520 of the example method 500. In one or more another example embodiments, at least one I/O interface, at least one antenna element, and the like may also be included in the example apparatus 1100.

In an embodiment, the measurement may be based on at least one of the following: a GNSS, a NTN positioning signal, or a TN positioning signal.

In some example embodiments, examples of means in the example apparatus 1100 may include circuitries. For example, an example of means 1110 may include a circuitry configured to perform the operation 510 of the example method 500, and an example of means 1120 may include a circuitry configured to perform the operation 520 of the example method 500.

The example apparatus 1100 may further include means comprising circuitry configured to perform the example method 500. In some example embodiments, examples of means may also include software modules and any other suitable function entities.

FIG. 12 shows a block diagram illustrating an example apparatus 1200 for NTN connection according to the example embodiments of the present disclosure. The apparatus, for example, may be at least part of a network device such as the second network device 130 associated with a target cell of a terminal device such as the UE 110 in the above examples.

As shown in FIG. 12, the example apparatus 1200 may include means 1210 for performing the operation 610 of the example method 600, and means 1220 for performing the operation 620 of the example method 600. In one or more another example embodiments, at least one I/O interface, at least one antenna element, and the like may also be included in the example apparatus 1200.

In an embodiment, the example apparatus 1200 may further include means for transmitting to the terminal device an indication indicating that the remaining measurement validity duration is insufficient based on determining that the remaining measurement validity duration of the terminal device is insufficient for connection with the target cell.

In an embodiment, the example apparatus 1200 may further include means for transmitting to the terminal device an indication indicating that the remaining measurement validity duration is absent in a case where the remaining measurement validity duration is absent in the network device.

In an embodiment, the example apparatus 1200 may further include means for determining a remaining serving time for the terminal device of the target cell; and means for transmitting to the terminal device the remaining serving time.

In an embodiment, the example apparatus 1200 may further include means for identifying the terminal device as a terminal device of a previous serving cell the remaining measurement validity duration of which the network device keeps.

In an embodiment, the measurement may be based on at least one of the following: a GNSS, a NTN positioning signal, or a TN positioning signal.

In some example embodiments, examples of means in the example apparatus 1200 may include circuitries. For example, an example of means 1210 may include a circuitry configured to perform the operation 610 of the example method 600, and an example of means 1220 may include a circuitry configured to perform the operation 620 of the example method 600.

The example apparatus 1200 may further include means comprising circuitry configured to perform the example method 600. In some example embodiments, examples of means may also include software modules and any other suitable function entities.

The example embodiments of the present disclosure also provide a computer readable medium comprising program instructions that, when executed by a terminal device such as the UE 110 in the above examples, may cause the terminal device at least to perform: entering into a non-connection mode with respect to a previous serving cell associated with a first network device; determining whether a condition associated with a measurement for at least location information is satisfied; and refraining from reporting a remaining measurement validity duration to a target cell associated with a second network device based on determining that the condition is satisfied.

In an embodiment, the computer readable medium may further include instructions that, when executed by the terminal device, may cause the terminal device to further perform: refraining from performing a measurement acquisition based on determining that the condition is satisfied.

In an embodiment, the condition may be satisfied in case of at least one of the following: the target cell is the previous serving cell; the first network device is the second network device; the remaining measurement validity duration exceeds a threshold; or receiving from the second network device an indication indicating that the remaining measurement validity duration is sufficient.

In an embodiment, the threshold may be predefined, received from the first network device, received from the second network device, or determined by the terminal device.

In an embodiment, the threshold received from the first network device may be a remaining serving time of the previous serving cell.

In an embodiment, the threshold received from the second network device may be a remaining serving time of the target cell.

In an embodiment, the threshold determined by the terminal device may be an expected duration of connection with the target cell.

In an embodiment, the computer readable medium may further include instructions that, when executed by the terminal device, may cause the terminal device to further perform: receiving from the second network device an indication; and reporting the remaining measurement validity duration to the second network device in a case where the indication indicates that the remaining measurement validity duration is absent in the second network device.

In an embodiment, the computer readable medium may further include instructions that, when executed by the terminal device, may cause the terminal device to further perform: receiving from the second network device an indication; and performing a measurement acquisition in a case where the indication indicates that the remaining measurement validity duration is insufficient.

In an embodiment, the computer readable medium may further include instructions that, when executed by the terminal device, may cause the terminal device to further perform: receiving from the first network device a remaining serving time of the previous serving cell or from the second network device a remaining serving time of the target cell; and performing a measurement acquisition in a case where the target cell is the previous serving cell, and the remaining measurement validity duration is less than the remaining serving time.

In an embodiment, the measurement may be based on at least one of the following: a GNSS, a NTN positioning signal, or a TN positioning signal.

The example embodiments of the present disclosure also provide a computer readable medium comprising program instructions that, when executed by a network device such as the first network device 120 associated with a previous serving cell of a terminal device such as the UE 110 in the above examples, may cause the network device at least to perform: determining a remaining serving time for the terminal device of the previous serving cell; and transmitting to the terminal device the remaining serving time, wherein the remaining serving time may be used by the terminal device as a threshold to determine whether a condition associated with a measurement for at least location information is satisfied.

In an embodiment, the measurement may be based on at least one of the following: a GNSS, a NTN positioning signal, or a TN positioning signal.

The example embodiments of the present disclosure also provide a computer readable medium comprising program instructions that, when executed by a network device such as the second network device 130 associated with a target cell of a terminal device such as the UE 110 in the above examples, may cause the network device at least to perform: determining whether a remaining measurement validity duration of the terminal device is sufficient for connection with the target cell; and transmitting to the terminal device an indication indicating that the remaining measurement validity duration is sufficient based on determining that the remaining measurement validity duration of the terminal device is sufficient for connection with the target cell, wherein the indication may be used by the terminal device to determine whether a condition associated with a measurement for at least location information is satisfied.

In an embodiment, the computer readable medium may further include instructions that, when executed by the network device, may cause the network device to further perform: transmitting to the terminal device an indication indicating that the remaining measurement validity duration is insufficient based on determining that the remaining measurement validity duration of the terminal device is insufficient for connection with the target cell.

In an embodiment, the computer readable medium may further include instructions that, when executed by the network device, may cause the network device to further perform: transmitting to the terminal device an indication indicating that the remaining measurement validity duration is absent in a case where the remaining measurement validity duration is absent in the network device.

In an embodiment, the computer readable medium may further include instructions that, when executed by the network device, may cause the network device to further perform: determining a remaining serving time for the terminal device of the target cell; and transmitting to the terminal device the remaining serving time.

In an embodiment, the computer readable medium may further include instructions that, when executed by the network device, may cause the network device to further perform: identifying the terminal device as a terminal device of a previous serving cell the remaining measurement validity duration of which the network device keeps.

In an embodiment, the measurement may be based on at least one of the following: a GNSS, a NTN positioning signal, or a TN positioning signal.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

The term “circuitry” throughout this disclosure may refer to one or more or all of the following: (a) hardware-only circuit implementations (such as implementations in only analog and/or digital circuitry); (b) combinations of hardware circuits and software, such as (as applicable) (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions); and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to one or all uses of this term in this disclosure, including in any claims. As a further example, as used in this disclosure, the term circuitry also covers an implementation of merely a hardware circuit or processor (or multiple processors) or portion of a hardware circuit or processor and its (or their) accompanying software and/or firmware. The term circuitry also covers, for example and if applicable to the claim element, a baseband integrated circuit or processor integrated circuit for a mobile device or a similar integrated circuit in server, a cellular network device, or other computing or network device.

Another example embodiment may relate to computer program codes or instructions which may cause an apparatus to perform at least respective methods described above. Another example embodiment may be related to a computer readable medium having such computer program codes or instructions stored thereon. In some embodiments, such a computer readable medium may include at least one storage medium in various forms such as a volatile memory and/or a non-volatile memory. The volatile memory may include, but not limited to, for example, a RAM, a cache, and so on. The non-volatile memory may include, but not limited to, a ROM, a hard disk, a flash memory, and so on. The non-volatile memory may also include, but are not limited to, an electric, a magnetic, an optical, an electromagnetic, an infrared, or a semiconductor system, apparatus, or device or any combination of the above.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Likewise, the word “connected”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the description using the singular or plural number may also include the plural or singular number respectively. The word “or” in reference to a list of two or more items, that word covers all of the following interpretations of the word: any of the items in the list, all of the items in the list, and any combination of the items in the list.

Moreover, conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

As used herein, the term “determine/determining” (and grammatical variants thereof) can include, not least: calculating, computing, processing, deriving, measuring, investigating, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

While some embodiments have been described, these embodiments have been presented by way of example, and are not intended to limit the scope of the disclosure. Indeed, the apparatus, methods, and systems described herein may be embodied in a variety of other forms; furthermore, various omissions, substitutions and changes in the form of the methods and systems described herein may be made without departing from the spirit of the disclosure. For example, while blocks are presented in a given arrangement, alternative embodiments may perform similar functionalities with different components and/or circuit topologies, and some blocks may be deleted, moved, added, subdivided, combined, and/or modified. At least one of these blocks may be implemented in a variety of different ways. The order of these blocks may also be changed. Any suitable combination of the elements and actions of the some embodiments described above can be combined to provide further embodiments. The accompanying claims and their equivalents are intended to cover such forms or modifications as would fall within the scope and spirit of the disclosure.

Abbreviations used in the description and/or in the figures are defined as follows:

| | |
|---|---|
| BS | base station |
| CFRA | contention free random access |
| C-RNTI | cell radio network temporary identifier |
| eMTC | enhanced machine type communication |
| GNSS | global navigation satellite system |
| GPS | global positioning system |
| ID | identifier |
| Msg2 | message 2 |
| Msg3 | message 3 |
| Msg4 | message 4 |
| MsgB | message B |
| NB-IoT | narrow band internet of things |
| NTN | non-terrestrial network |
| RA | random access |
| RAR | random access response |
| RRC | radio resource control |
| SAT | satellite |
| TN | terrestrial network |
| UE | user equipment |

1.-50. (canceled)

51. A terminal device, comprising:
at least one processor; and
at least one memory storing instructions that, when executed by the at least one processor, cause the terminal device at least to perform:
entering into a non-connection mode with respect to a previous serving cell associated with a first network device;
determining whether a condition associated with a measurement for at least location information is satisfied; and
refraining from reporting a remaining measurement validity duration to a target cell associated with a second network device based on determining that the condition is satisfied.

52. The terminal device of claim 51, wherein the instructions, when executed by the at least one processor, cause the terminal device to further perform:
refraining from performing a measurement acquisition based on determining that the condition is satisfied.

53. The terminal device of claim 51, wherein the condition is satisfied in case of at least one of the following:
the target cell is the previous serving cell;
the first network device is the second network device;
the remaining measurement validity duration exceeds a threshold; or
receiving from the second network device an indication indicating that the remaining measurement validity duration is sufficient.

54. The terminal device of claim 53, wherein the threshold is predefined, received from the first network device, received from the second network device, or determined by the terminal device.

55. The terminal device of claim 54, wherein the threshold received from the first network device is a remaining serving time of the previous serving cell.

56. The terminal device of claim 54, wherein the threshold received from the second network device is a remaining serving time of the target cell.

57. The terminal device of claim 54, wherein the threshold determined by the terminal device is an expected duration of connection with the target cell.

58. The terminal device of claim 51, wherein the instructions, when executed by the at least one processor, cause the terminal device to further perform:
receiving from the second network device an indication; and
reporting the remaining measurement validity duration to the second network device in a case where the indication indicates that the remaining measurement validity duration is absent in the second network device.

59. The terminal device of claim 51, wherein the instructions, when executed by the at least one processor, cause the terminal device to further perform:
receiving from the second network device an indication; and
performing a measurement acquisition in a case where the indication indicates that the remaining measurement validity duration is insufficient.

60. The terminal device of claim 51, wherein the instructions, when executed by the at least one processor, cause the terminal device to further perform:
receiving from the first network device a remaining serving time of the previous serving cell or from the second network device a remaining serving time of the target cell; and
performing a measurement acquisition in a case where the target cell is the previous serving cell, and the remaining measurement validity duration is less than the remaining serving time.

61. The terminal device of claim 51, wherein the measurement is based on at least one of the following: a global navigation satellite system, a non-terrestrial network positioning signal, or a terrestrial network positioning signal.

62. A method performed by a terminal device, comprising:
entering into a non-connection mode with respect to a previous serving cell associated with a first network device;
determining whether a condition associated with a measurement for at least location information is satisfied; and
refraining from reporting a remaining measurement validity duration to a target cell associated with a second network device based on determining that the condition is satisfied.

63. The method of claim 62, further comprising:
refraining from performing a measurement acquisition based on determining that the condition is satisfied.

64. The method of claim 62, wherein the condition is satisfied in case of at least one of the following:
the target cell is the previous serving cell;
the first network device is the second network device;
the remaining measurement validity duration exceeds a threshold; or
receiving from the second network device an indication indicating that the remaining measurement validity duration is sufficient.

65. The method of claim 64, wherein the threshold is predefined, received from the first network device, received from the second network device, or determined by the terminal device.

66. The method of claim 62, further comprising:
receiving from the second network device an indication; and
reporting the remaining measurement validity duration to the second network device in a case where the indication indicates that the remaining measurement validity duration is absent in the second network device.

67. The method of claim 62, further comprising:
receiving from the second network device an indication; and
performing a measurement acquisition in a case where the indication indicates that the remaining measurement validity duration is insufficient.

68. The method of claim 62, further comprising:
receiving from the first network device a remaining serving time of the previous serving cell or from the second network device a remaining serving time of the target cell; and
performing a measurement acquisition in a case where the target cell is the previous serving cell, and the remaining measurement validity duration is less than the remaining serving time.

69. An apparatus as a terminal device, comprising:
means for entering into a non-connection mode with respect to a previous serving cell associated with a first network device;
means for determining whether a condition associated with a measurement for at least location information is satisfied; and
means for refraining from reporting a remaining measurement validity duration to a target cell associated with a second network device based on determining that the condition is satisfied.

70. The apparatus of claim 69, further comprising means for performing a method performed by a terminal device, the method comprising the steps of:
entering into a non-connection mode with respect to a previous serving cell associated with a first network device;
determining whether a condition associated with a measurement for at least location information is satisfied; and
refraining from reporting a remaining measurement validity duration to a target cell associated with a second network device based on determining that the condition is satisfied.
